(19) United States
(12) Patent Application Publication
(10) Pub. No.: US 2025/0284070 A1
(43) Pub. Date: Sep. 11, 2025

(54) OPTICAL FIBER ACCESSORY

(71) Applicant: Gloriole Electroptic Technology Corp., Kaohsiung City (TW)

(72) Inventors: Hsien-Hsin HSU, Kaohsiung City (TW); Yu-Cheng CHEN, Kaohsiung City (TW); Wu-Li CHU, Kaohsiung City (TW); Jim LIN, Kaohsiung City (TW)

(21) Appl. No.: 19/073,431

(22) Filed: Mar. 7, 2025

(30) Foreign Application Priority Data
Mar. 11, 2024 (TW) 113202421

(51) Int. Cl. G02B 6/38

(52) U.S. Cl. CPC G02B 6/3882; G02B 6/3849

(57) ABSTRACT

An optical fiber accessory includes following components. The seat defines an insertion slot extending in an insertion direction. The multi-core terminal defines core slots extending in the insertion direction and in spatial communication with the insertion slot. The cover is separably attached to the seat, and defines an internal space in spatial communication with the core slots. The loop module is disposed in the multi-core terminal, extends into the internal space, and includes straight line segments extending from the core slots into the internal space, and curve line segments disposed in the internal space. A number of the curve line segments is half of that of the straight line segments. Two ends of each of the curve line segments are respectively connected to two of the straight line segments.

### CROSS-REFERENCE TO RELATED APPLICATION

This application claims priority to Taiwanese Utility Model patent application Ser. No. 11/320,2421, filed on Mar. 11, 2024, the entire disclosure of which is incorporated by reference herein.

### FIELD

The disclosure relates to an optical fiber accessory, and more particularly to an optical fiber accessory for inspection.

### BACKGROUND

Generally, when an optical fiber network is being built, one or more of optical fiber patch cables equipped with connectors (such as QSFP-DD connectors) can be used to connect a host in the server room to a terminal apparatus at the client's end through connecting a plurality of relay devices therebetween. After the optical fiber network is built, personnel have to go to the two places where the host and the terminal apparatus are installed, and connect inspection devices respectively to the host and the terminal apparatus, in order to inspect and verify performances thereof (including loss and signal quality, etc.). However, this inspection method needs a lot of manpower and inspection devices; if the host and the optical fiber patch cables have been installed, but the terminal apparatus has not been set up, the inspection cannot be performed, which is inconvenient.

### SUMMARY

Therefore, an object of the disclosure is to provide an optical fiber accessory that can alleviate at least one of the drawbacks of the prior art.

According to the disclosure, the optical fiber accessory includes a seat, a multi-core terminal, a cover and a loop module. The seat defines an insertion slot that extends in an insertion direction. The multi-core terminal is disposed in the seat, and defines a plurality of core slots that are spaced apart from each other in a width direction transverse to the insertion direction. Each of the plurality of core slots extends in the insertion direction and is in spatial communication with the insertion slot. The cover is separably attached to the seat in the insertion direction, and defines an internal space that is in spatial communication with the plurality of core slots. The loop module is disposed in the multi-core terminal, extends into the internal space, and includes a plurality of straight line segments that are respectively disposed in and extend from the plurality of core slots into the internal space in a direction opposite to the insertion direction, and a plurality of curve line segments that are disposed in the internal space, and that are connected to the plurality of straight line segments. A number of the plurality of curve line segments is half of that of the plurality of straight line segments. Two ends of each of the plurality of curve line segments are respectively connected to two of the plurality of straight line segments.

### BRIEF DESCRIPTION OF THE DRAWINGS

Other features and advantages of the disclosure will become apparent in the following detailed description of the embodiment(s) with reference to the accompanying drawings. It is noted that various features may not be drawn to scale.

FIG. 1 is a perspective view illustrating a first embodiment of an optical fiber accessory according to the disclosure.

FIG. 2 is a partly exploded perspective view of the first embodiment.

FIG. 3 is a sectional view of the first embodiment.

FIG. 4 is a fragmentary sectional view of the first embodiment, illustrating a multi-core terminal of the first embodiment.

FIG. 5 is a partly exploded perspective view of a second embodiment according to the disclosure.

FIG. 6 is a sectional view of the second embodiment.

FIG. 7 is a perspective view illustrating a third embodiment according to the disclosure.

FIG. 8 is a partly exploded perspective view of the third embodiment.

FIG. 9 is a sectional view of the third embodiment.

### DETAILED DESCRIPTION

Before the disclosure is described in greater detail, it should be noted that where considered appropriate, reference numerals or terminal portions of reference numerals have been repeated among the figures to indicate corresponding or analogous elements, which may optionally have similar characteristics.

It should be noted herein that for clarity of description, spatially relative terms such as “top,” “bottom,” “upper,” “lower,” “on,” “above,” “over,” “downwardly,” “upwardly” and the like may be used throughout the disclosure while making reference to the features as illustrated in the drawings. The features may be oriented differently (e.g., rotated 90 degrees or at other orientations) and the spatially relative terms used herein may be interpreted accordingly.

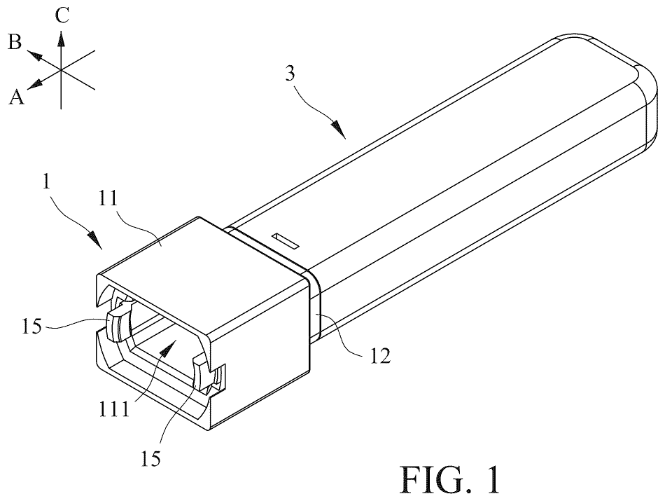

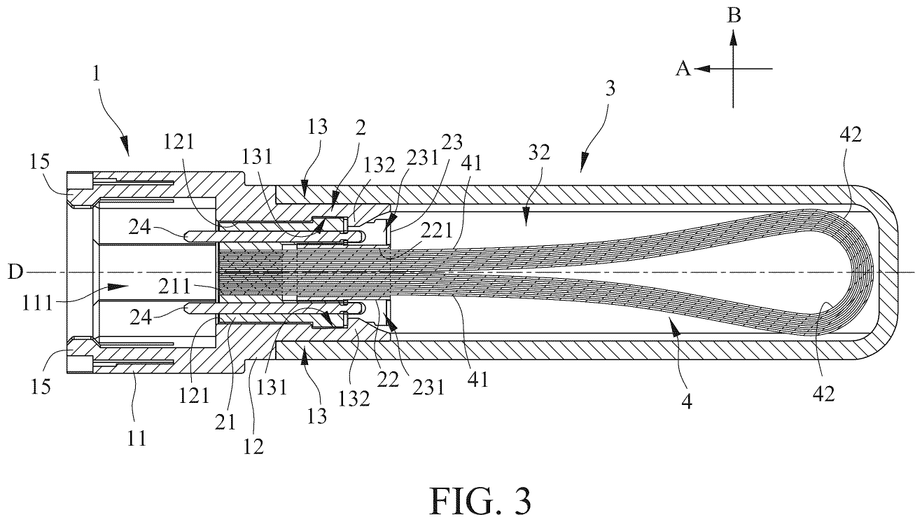

Referring to FIGS. 1 to 3, a first embodiment of an optical fiber accessory according to the disclosure includes a seat 1 that defines an insertion slot 111 extending in an insertion direction (A), a multi-core terminal 2 that is disposed in the seat 1, a cover 3 that is separably attached to the seat 1 in the insertion direction (A), and a loop module 4 that is disposed in the multi-core terminal 2 and that extends into the cover 3.

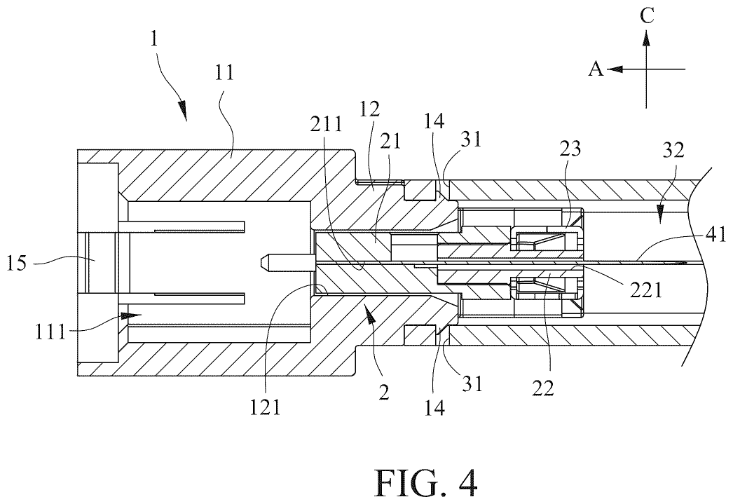

The seat 1 includes a receipt portion 11 that defines the insertion slot 111, an accommodation portion 12 that extends from the receipt portion 11 in a direction opposite to the insertion direction (A), and that defines an accommodation space 121 in spatial communication with the insertion slot 111 and configured for disposition of the multi-core terminal 2, two limit hook portions 13 that extend from the accommodation portion 12 into the cover 3 in the direction opposite to the insertion direction (A), that are spaced apart from each other in a width direction (B) transverse to the insertion direction (A), and that are configured to limit the multi-core terminal 2 in the accommodation space 121, two engagement portions 14 (see FIG. 4) that extend from the accommodation portion 12 and away from each other respectively in two directions transverse to the insertion direction (A) and the width direction (B), and that are configured to be engaged with the cover 3, and two hook portions 15 that integrally extend from the receipt portion 11 in the insertion direction (A). Each of the limit hook portions 13 has a limit groove 131 and a hook structure 132; specifically, the limit groove 131 recesses from an inner surface of the limit hook portion 13 that faces the other one of the limit hook portions 13, and the hook structure 132 is consecutive in position to the limit hook portion 131 along the direction opposite to the insertion direction (A).

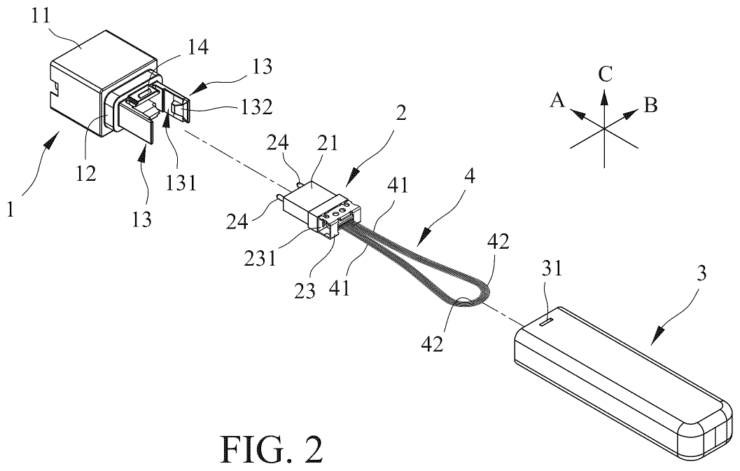

Referring to FIGS. 2 to 4, the multi-core terminal 2 includes a terminal body 21 that is located in the seat 1 (specifically, in the accommodation space 121), and that defines a plurality of core slots 211, a sleeve member 22 that is partially inserted into an end of the terminal body 21 opposite to the insertion slot 111 in the insertion direction (A), and that defines a through hole 221 extending in the insertion direction (A) and consecutive to the core slots 211 in the direction opposite to the insertion direction (A) (i.e., in spatial communication with the core slots 211), a position seat 23 that is adjacent to the end of the terminal body 21 opposite to the insertion slot 111, that is disposed around the sleeve member 22, and that defines two position holes 231 arranged in the width direction (B) and respectively provided for the hook structures 132 of the limit hook portions 13 to be engaged therewith, and two guide pins 24 that are respectively located on opposite sides of the loop module 4 in the width direction (B), and that extend through the terminal body 21. In some embodiments, the guide pins 24 may be omitted. The end of the terminal body 21 opposite to the insertion slot 111 widens relative to another end of the terminal body 21 proximate to the insertion slot 111, and two opposite portions of the end of the terminal body 21 in the width direction (B) are used for engaging the limit grooves 131 of the limit hook portions 13. In this embodiment, a number of the plurality of core slots 211 is twelve, but is not limited thereto, and the core slots 211 extend in the insertion direction (A), are in spatial communication with the insertion slot 111, and are spaced apart from each other in the width direction (B). Through the limit hook portions 13 (specifically, the limit grooves 131 and the hook structures 132), the terminal body 21 and the position seat 23 are limited in position, thereby limiting the multi-core terminal 2 in the accommodation space 121. For each of the guide pins 24, one end of the guide pin 24 extends into the insertion slot 111 in the insertion direction (A), and another end of the guide pin 24 extends through the terminal body 21 in the direction opposite to the insertion direction (A) and is engaged with the position seat 23. In practice, when the embodiment is being assembled, the guide pins 24 are pre-coupled to the position seat 23, and the position seat 23, along with the guide pins 24, is connected to the terminal body 21.

The cover 3 is formed with two mortises 31 that are spaced apart from each other in a height direction (C) transverse to the insertion direction (A) and the width direction (B), and that are respectively configured for the engagement portions 14 to be engaged therewith. The cover 3 defines an internal space 32 that is in spatial communication with the through hole 221 and the core slots 211.

The loop module 4 extends into the internal space 32, and includes a plurality of straight line segments 41 that are respectively disposed in and extend from the core slots 211 into the internal space 32 in the direction opposite to the insertion direction (A), and a plurality of curve line segments 42 that are disposed in the internal space 32, and that are connected to the straight line segments 41. A number of the straight line segments 41 is a positive integer multiple of either 8 or 12 (in this embodiment, there are twelve straight line segments 41), and a number of the curve line segments 42 is half of that of the straight line segments 41 (in this embodiment, there are six curve line segments 42). Two ends of each of the curve line segments 42 are respectively connected to two of the straight line segments 41. The number of the core slots 211 is the same as the number of the straight line segments 41; thus, in practice, the number of the core slots 211 has to be adjusted according to the number of the straight line segments 41.

For any two of the straight line segments 41 that are connected to a same one of the curve line segments 42, a distance between one of the straight line segments (41) and a symmetrical axis (D) in the width direction (B) is equal to a distance between the other one of the straight line segments 41 and the symmetrical axis (D) in the width direction (B), the symmetrical axis (D) being parallel to the insertion direction (A) and extending through a center portion of the curve line segments 42 in the width direction (B). Explicitly, the straight line segments 41 are divided into two groups by the symmetrical axis (D), and the numbers of the straight line segments 41 in the two groups are the same; for example, in this embodiment, there are six straight line segments 41 in each group. The two groups of the straight line segments 41 are used for signal communication, one of them is a transmitting group, and the other one is a receiving group. For each of the curve line segments 42, those of the straight line segments 41 connected thereto are respectively in the transmitting group and the receiving group.

When an optical fiber apparatus (not shown) has been set up and connected to one end of an optical fiber patch cable (not shown), the other end of the optical fiber patch cable that has not been connected to another optical fiber apparatus may be inserted into the insertion slot 111 (e.g., through a QSFP-DD connector thereof). Through each of the curve line segments 42 being connected to one straight line segment 41 from the transmitting group and one straight line segment 41 from the receiving group, loopback is realized to simulate data communication, thereby achieving the object of self-inspection. In addition to detection of physical quantities (such as insertion loss), through the loopback, by virtue of comparing signals transmitted and received through the optical fiber network, the signal quality of the optical fiber network may be identified, and the performance of the optical fiber apparatus, such as communication capability, receiving sensitivity, etc., may be verified; thus, the range of the self-inspection and items to be inspected are increased. Besides, the present disclosure allows the open loop to be converted to the closed loop to achieve the effect of protecting the optical fiber network. In some embodiments, the straight line segments 41 and/or the curve line segments 42 may be embodied as flexible ribbon cables.

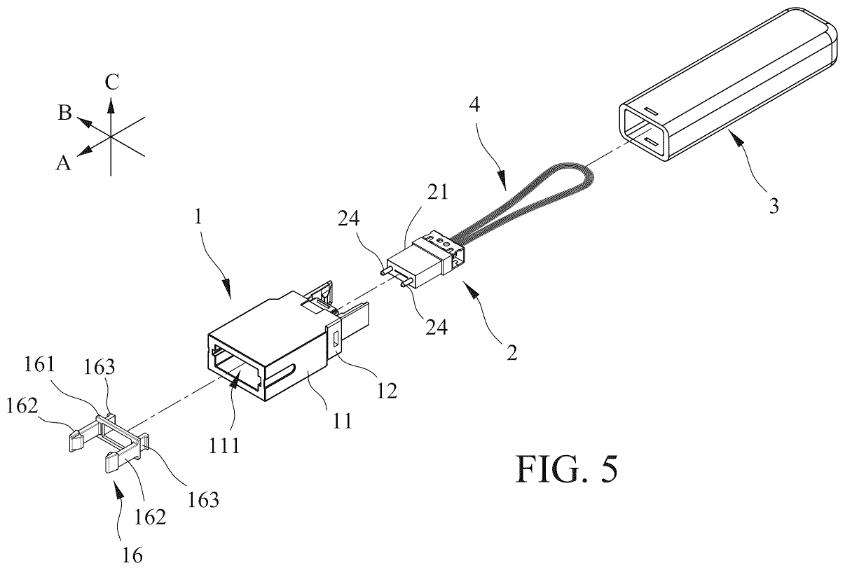

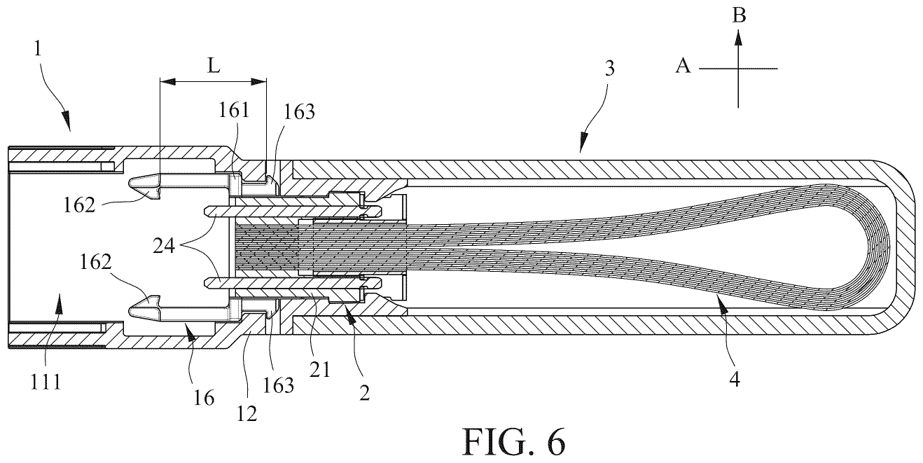

Referring to FIGS. 5 and 6, a second embodiment of the disclosure is provided, which is similar to the first embodiment, and only the differences therebetween are illustrated in the following. The first embodiment is adapted to be used with an optical fiber patch cable equipped with a multi-core fiber connector (not shown), and the second embodiment is adapted to be used with an optical fiber patch cable equipped with a connector with other specifications (not shown). In the second embodiment, the hook portions 15 of the seat 1 (see FIG. 1) are omitted. The seat 1 of the second embodiment further includes a connection unit 16 that is sleeved on an end of the terminal body 21 opposite to the loop module 4. The connection unit 16 has a frame portion 161 that partially covers and surrounds the terminal body 21, and that is configured for the guide pins 24 to extend therethrough in the insertion direction (A), two first connection hooks 162 that extend from the frame portion 161 into the insertion slot 111 in the insertion direction (A), and that are spaced apart from each other in the width direction (B), and two second connection hooks 163 that extend from the frame portion 161 in the direction opposite to the insertion direction (A), that are engaged with the accommodation portion 12, and that are spaced apart from each other in the width direction (B). A distance between the first connection hooks 162 in the width direction (B) is greater than a distance between the second connection hooks 163 in the width direction (B). In some embodiments, each of the first connection hooks 162 has a distal nub, and each of the second connection hooks 163 has a distal nub. A distance (L) between the distal nub of one of the first connection hooks 162 and the distal nub of one of the second connection hooks 163 in the insertion direction (A) is 6.85±0.1 millimeters (mm) (i.e., ranges from 6.75 to 6.95 mm). Through the second connection hooks 163, the connection unit 16 is engaged with the accommodation portion 12, and the first connection hooks 162 is adapted for hooking an optical fiber patch cable that is inserted into the insertion slot 111 (specifically, for hooking the connector of the optical fiber patch cable).

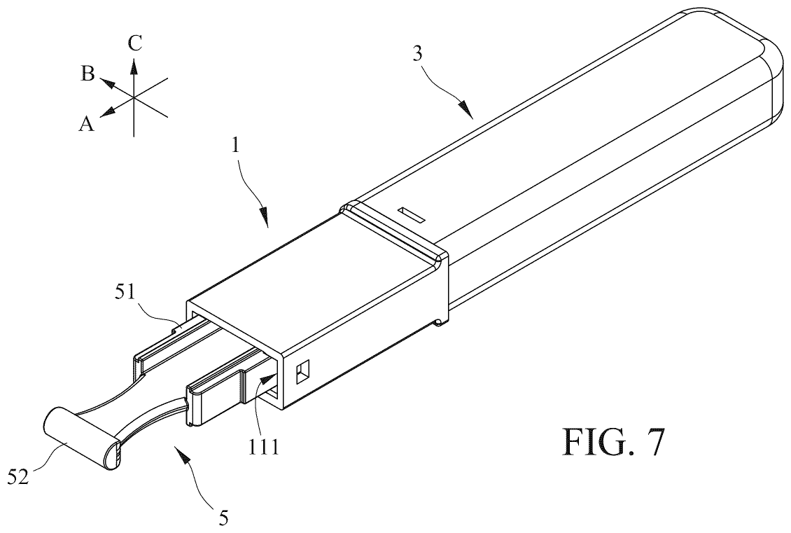

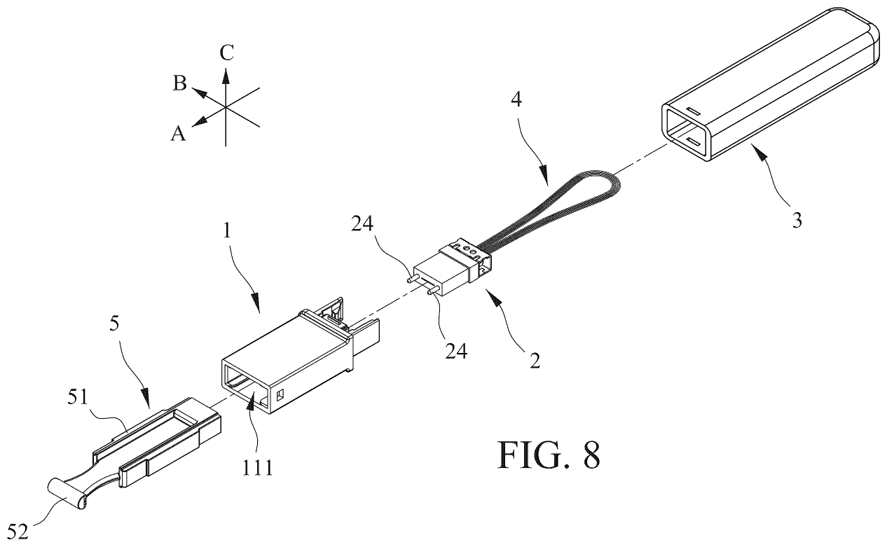

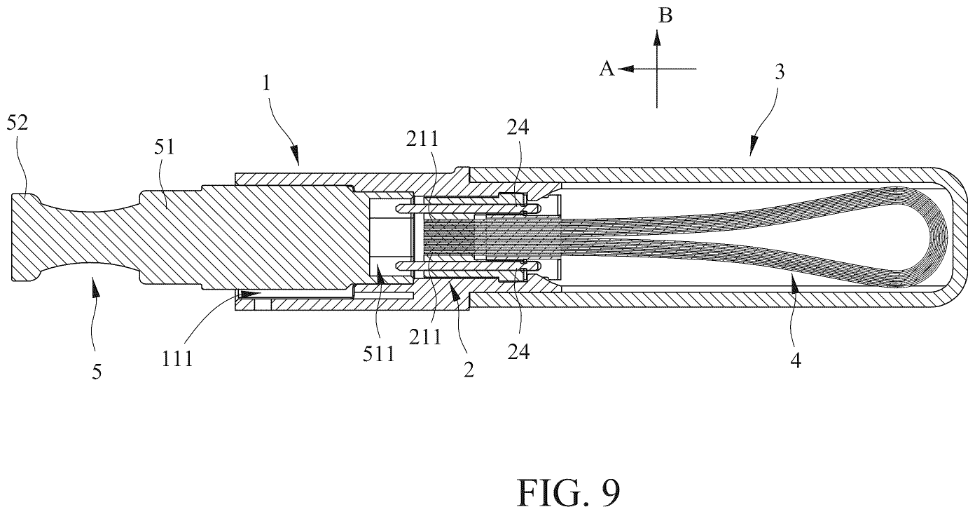

Referring to FIGS. 7 to 9, a third embodiment of the disclosure is provided, which is similar to the first embodiment, and only the differences therebetween are illustrated in the following. The first embodiment is adapted to be used with an optical fiber patch cable equipped with a multi-core fiber connector (not shown), and the third embodiment is adapted to be used with an optical fiber patch cable equipped with a connector with other specifications (not shown). In the third embodiment, the hook portions 15 of the seat 1 (see FIG. 1) are omitted. The third embodiment further includes a dustproof cap 5 that is configured to be separably inserted into the insertion slot 111, and that has a cap body portion 51 being able to be partially disposed in the insertion slot 111 and a handle portion 52 extending from the cap body portion 51 in the insertion direction (A). The cap body portion 51 is formed with a groove 511 that recesses in the insertion direction (A), and that is in spatial communication with the insertion slot 111, and the one end of each of the guide pins 24 that extends into the insertion slot 111 is located in the groove 511. The dustproof cap 5 can be inserted into the insertion slot 111 when the embodiment is not being used, preventing entry of dirt and debris.

To sum up, the present disclosure allows personnel to, after an optical fiber patch cable has been connected to an optical fiber apparatus (e.g., a host) but has not been connected to another optical fiber apparatus (e.g., a terminal apparatus), insert an end of the optical fiber patch cable into the insertion slot 111 to carry out inspection, and to verify the quality of the current optical fiber network. In this way, the personnel do not need to run to many places, which significantly reduces manpower and improves the inspection efficiency; meanwhile, it is ensured that after the another optical fiber apparatus is set up and connected to the optical fiber apparatus through the optical fiber patch cable, the optical fiber network is ready to be used, so the object of the disclosure is indeed achieved.

In the description above, for the purposes of explanation, numerous specific details have been set forth in order to provide a thorough understanding of the embodiment(s). It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects; such does not mean that every one of these features needs to be practiced with the presence of all the other features. In other words, in any described embodiment, when implementation of one or more features or specific details does not affect implementation of another one or more features or specific details, said one or more features may be singled out and practiced alone without said another one or more features or specific details. It should be further noted that one or more features or specific details from one embodiment may be practiced together with one or more features or specific details from another embodiment, where appropriate, in the practice of the disclosure.

While the disclosure has been described in connection with what is (are) considered the exemplary embodiment(s), it is understood that this disclosure is not limited to the disclosed embodiment(s) but is intended to cover various arrangements included within the spirit and scope of the broadest interpretation so as to encompass all such modifications and equivalent arrangements.

What is claimed is:

1. An optical fiber accessory, comprising:
a seat defining an insertion slot that extends in an insertion direction;
a multi-core terminal disposed in said seat, and defining a plurality of core slots that are spaced apart from each other in a width direction transverse to the insertion direction, each of said plurality of core slots extending in the insertion direction and being in spatial communication with said insertion slot;
a cover separably attached to said seat in the insertion direction, and defining an internal space that is in spatial communication with said plurality of core slots; and
a loop module disposed in said multi-core terminal, extending into said internal space, and including a plurality of straight line segments that are respectively disposed in and extend from said plurality of core slots into said internal space in a direction opposite to the insertion direction, and a plurality of curve line segments that are disposed in said internal space, and that are connected to said plurality of straight line segments, a number of said plurality of curve line segments being half of that of said plurality of straight line segments, two ends of each of said plurality of curve line segments being respectively connected to two of said plurality of straight line segments.

2. The optical fiber accessory as claimed in claim 1, wherein for any two of said plurality of straight line segments that are connected to a same one of said plurality of curve line segments, a distance between one of said plurality of straight line segments and a symmetrical axis in the width direction is equal to a distance between another one of said plurality of straight line segments and the symmetrical axis in the width direction, the symmetrical axis being parallel to the insertion direction and extending through a center portion of said plurality of curve line segments in the width direction.

3. The optical fiber accessory as claimed in claim 1, wherein
said seat includes:
a receipt portion that defines said insertion slot;
an accommodation portion that extends from said receipt portion in the direction opposite to the insertion direction, and that defines an accommodation space configured for disposition of said multi-core terminal and in spatial communication with said insertion slot;
two limit hook portions that extend from said accommodation portion into said cover in the direction opposite to the insertion direction, that are spaced apart from each other in the width direction, and that are configured to limit said multi-core terminal in said accommodation space; and
two engagement portions that extend from said accommodation portion away from each other respectively in two directions transverse to the insertion direction and the width direction, and that are configured to be engaged with said cover.

4. The optical fiber accessory as claimed in claim 3, wherein
said multi-core terminal includes:
a terminal body that is located in said seat, and that defines said plurality of core slots;
a sleeve member that is partially inserted into an end of said terminal body opposite to said insertion slot in the insertion direction, and that defines a through hole extending in the insertion direction and configured for disposition of said plurality of straight line segments;
a position seat that is adjacent to said end of said terminal body opposite to said insertion slot, that is disposed around said sleeve member, and that defines two position holes arranged in the width direction and respectively provided for said limit hook portions to be engaged therewith; and
two guide pins that are respectively located on opposite sides of said loop module in the width direction, and that extend through said terminal body, and
for each of said guide pins, one end of said guide pin extends into said insertion slot in the insertion direction, and another end of said guide pin extends through said terminal body in the direction opposite to the insertion direction and is engaged with said position seat.

5. The optical fiber accessory as claimed in claim 4, wherein
said seat further includes a connection unit that is sleeved on an end of said terminal body opposite to said loop module, and
said connection unit has a frame portion that surrounds said terminal body, and that is configured for said guide pins to extend therethrough in the insertion direction, two first connection hooks that extend from said frame portion into said insertion slot in the insertion direction, and that are spaced apart from each other in the width direction, and two second connection hooks that extend from said frame portion in the direction opposite to the insertion direction, that are engaged with said accommodation portion, and that are spaced apart from each other in the width direction.

6. The optical fiber accessory as claimed in claim 5, wherein a distance between said first connection hooks in the width direction is greater than a distance between said second connection hooks in the width direction.

7. The optical fiber accessory as claimed in claim 5, wherein each of said first connection hooks has a distal nub, each of said second connection hooks having a distal nub, a distance between said distal nub of one of said first connection hooks and said distal nub of one of said second connection hooks in the insertion direction ranging from 6.75 to 6.95 millimeters.

8. The optical fiber accessory as claimed in claim 4, further comprising a dustproof cap that is configured to be separably inserted into said insertion slot, and that has a cap body portion being able to be partially disposed in said insertion slot and a handle portion extending from said cap body portion in the insertion direction.

9. The optical fiber accessory as claimed in claim 8, wherein said cap body portion is formed with a groove that recesses in the insertion direction, and that is in spatial communication with said insertion slot, said one end of each of said guide pins being located in said groove.

10. The optical fiber accessory as claimed in claim 3, wherein said cover is formed with two mortises that are spaced apart from each other in a height direction transverse to the insertion direction and the width direction, and that are respectively configured for said engagement portions of said seat to be engaged therewith.

11. The optical fiber accessory as claimed in claim 3, wherein said seat further includes two hook portions that extend from said receipt portion in the insertion direction.

12. The optical fiber accessory as claimed in claim 1, wherein
said multi-core terminal includes:
a terminal body that is located in said seat, and that defines said plurality of core slots;
a sleeve member that is partially inserted into an end of said terminal body opposite to said insertion slot in the insertion direction, and that defines a through hole extending in the insertion direction and configured for disposition of said plurality of straight line segments;
a position seat that is adjacent to said end of said terminal body opposite to said insertion slot, that is disposed around said sleeve member, and that defines two position holes arranged in the width direction; and
two guide pins that are respectively located on opposite sides of said loop module in the width direction, and that extend through said terminal body, and
for each of said guide pins, one end of said guide pin extends into said insertion slot in the insertion direction, and another end of said guide pin extends through said terminal body in the direction opposite to the insertion direction and is engaged with said position seat.

13. The optical fiber accessory as claimed in claim 12, wherein
said seat includes a connection unit that is sleeved on an end of said terminal body opposite to said loop module, and
said connection unit has a frame portion that surrounds said terminal body, and that is configured for said guide pins to extend therethrough in the insertion direction, two first connection hooks that extend from said frame portion into said insertion slot in the insertion direction, and that are spaced apart from each other in the width direction, and two second connection hooks that extend from said frame portion in the direction opposite to the insertion direction, and that are spaced apart from each other in the width direction.

14. The optical fiber accessory as claimed in claim 13, wherein each of said first connection hooks has a distal nub, each of said second connection hooks having a distal nub, a distance between said distal nub of one of said first connection hooks and said distal nub of one of said second connection hooks in the insertion direction ranging from 6.75 to 6.95 millimeters.

15. The optical fiber accessory as claimed in claim 12, further comprising a dustproof cap that is configured to be separably inserted into said insertion slot, and that has a cap body portion being able to be partially disposed in said insertion slot and a handle portion extending from said cap body portion in the insertion direction.

16. The optical fiber accessory as claimed in claim 15, wherein said cap body portion is formed with a groove that recesses in the insertion direction, and that is in spatial communication with said insertion slot, said one end of each of said guide pins being located in said groove.

17. The optical fiber accessory as claimed in claim 1, further comprising a dustproof cap that is configured to be separably inserted into said insertion slot, and that has a cap body portion being able to be partially disposed in said insertion slot and a handle portion extending from said cap body portion in the insertion direction.

18. The optical fiber accessory as claimed in claim 1, wherein a number of said plurality of straight line segments is a positive integer multiple of either 8 or 12.
